(19) United States
(12) Patent Application Publication
(10) Pub. No.: US 2018/0341499 A1
(43) Pub. Date: Nov. 29, 2018

(54) UNIVERSAL PLATFORM APPLICATION SUPPORT FOR PLUGIN MODULES

(71) Applicant: MICROSOFT TECHNOLOGY LICENSING, LLC, Redmond, WA (US)

(72) Inventor: David C. TSE, Kirkland, WA (US)

(73) Assignee: MICROSOFT TECHNOLOGY LICENSING, LLC, Redmond, WA (US)

(21) Appl. No.: 15/605,889

(22) Filed: May 25, 2017

(51) Int. Cl. G06F 9/44; G06F 9/445

(52) U.S. Cl. CPC G06F 9/4443; G06F 8/65

(57) ABSTRACT

Universal platform application support for plugin modules is provided. Connectivity to a universal platform application may be provided for plugin modules through an application service. Upon being launched on the same device as the universal platform application, a plugin module may submit a request for connection through the application service. Once connected, the universal platform application may receive a request for activation from the plugin module and may determine whether to activate the plugin module through an internal decision process or manual input. Subsequently, a user interface of the plugin module may be allowed to be visible and a user interface of the universal platform application may be hidden or pushed to background. When the plugin module is deactivated based upon completion of its tasks, the user interface of the plugin module may be hidden and the user interface of the universal platform application may be rendered visible.

### BACKGROUND

Universal platform applications, which are part of a platform-homogeneous application architecture, may be executed on a number of operating systems, operating system versions, and/or devices without a need for customization or different versions of the application. Despite advantages and efficiencies of universal platform applications, such programs may also be associated with inherent limitations, such as an inability to interoperate with plugin modules.

Plugin modules may provide complementary functionality to applications in specific areas. For example, an environment control module may control operations of various environmental controls such as shades, lighting, ambient temperature, etc. in a room. However, such controls may have to be handled separately (and manually in some cases) from a universal platform application executed in the room such as a meeting room management application controlling communications and online meetings in the room.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to universal platform application support for plugin modules. In some examples, a connection request may be received at a universal platform application through an application service connection from a plugin module. In response to receiving another request to be activated from the plugin module, the universal platform application may determine whether to activate the plugin module. If the determination is to activate the plugin module, a user interface of the plugin module may be allowed to be visible and a user interface of the universal platform application may be hidden or pushed to background. If and when the plugin module is deactivated, the user interface of the plugin module may be hidden and the user interface of the universal platform application may be rendered visible.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates conceptually a universal platform application and its installation on a computing device;

FIG. 2 illustrates conceptually a universal platform application with support for plugin modules and its installation on a computing device;

FIG. 3 includes a display diagram that conceptually illustrates providing support for plugin modules by universal platform applications through an application service interface;

FIG. 4 illustrates an example sequence of universal platform application and plugin module user interfaces during activation and deactivation of a plugin module;

FIG. 5 is a networked environment, where a system according to embodiments may be implemented;

FIG. 6 is a block diagram of an example communal meeting device, which may be used to execute a universal platform application with support for plugin modules; and

FIG. 7 includes a logic flow diagram that illustrates a process for providing universal platform application support for plugin modules, according to at least some embodiments disclosed herein.

### DETAILED DESCRIPTION

As briefly described above, embodiments may provide universal platform application support for plugin modules. According to some examples, a universal platform application may provide connectivity to plugin modules through an application service. Upon being launched on the same device as the universal platform application, a plugin module may submit a request for connection through the application service. Once connected, the universal platform application may receive a request for activation from the plugin module and may determine whether to activate the plugin module through an internal decision process or manual input (e.g., user response to a prompt). If the determination is to activate the plugin module, a user interface of the plugin module may be allowed to be visible and a user interface of the universal platform application may be hidden or pushed to background. When the plugin module completes its process or is deactivated based on a time period expiration, the user interface of the plugin module may be hidden and the user interface of the universal platform application may be rendered visible.

A universal platform application, as used herein, refers to an application that is part of a platform-homogeneous application architecture. Thus, a universal platform application may be executed on a number of operating systems, operating system versions, and/or devices without a need for customization or different versions of the application. For example, the same universal platform application may be installed and executed on a desktop platform and a mobile platform. Some universal platform applications may not indicate having been written for a specific operating system or platform in their manifest build; instead, they may target one or more device families, such as a PC, smartphone, tablet, or gaming systems. These extensions may allow the application to automatically utilize the capabilities that are available to the particular device it is currently running on. The platform-agnostic nature of these applications may allow enhanced user experience aspects in addition to efficiency and reduced complexity. For example, a universal platform application executed on a smartphone may start behaving the way it would if it were running on a PC when the smartphone is connected to a desktop computer or a suitable docking station. On the other hand, being platform agnostic may mean for some of these applications limitations over platform-specific applications. For example, a number and type of Application Programming Interfaces (APIs) available in the application may be limited. Thus, a functionality of a universal platform application may also be subject to constraints based on its design such as a lack of ability to interoperate with plugin modules.

Compared to universal platform applications, desktop applications, as referred to herein, are typically platform-specific such as operating system, operating system version, device, etc. While their specificity may make it more difficult to manage desktop applications on different devices or operating systems, it may also provide them with a higher degree of freedom with respect to functionality. Operating system or device specific APIs may be provided in desktop applications, for example. Thus, desktop applications may lend themselves more toward certain functionality. For example, functionality that is associated with monitoring and reacting to events that happen at operating system or hardware level.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable readable storage medium can, for example, be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for executing universal platform applications and plugin modules. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

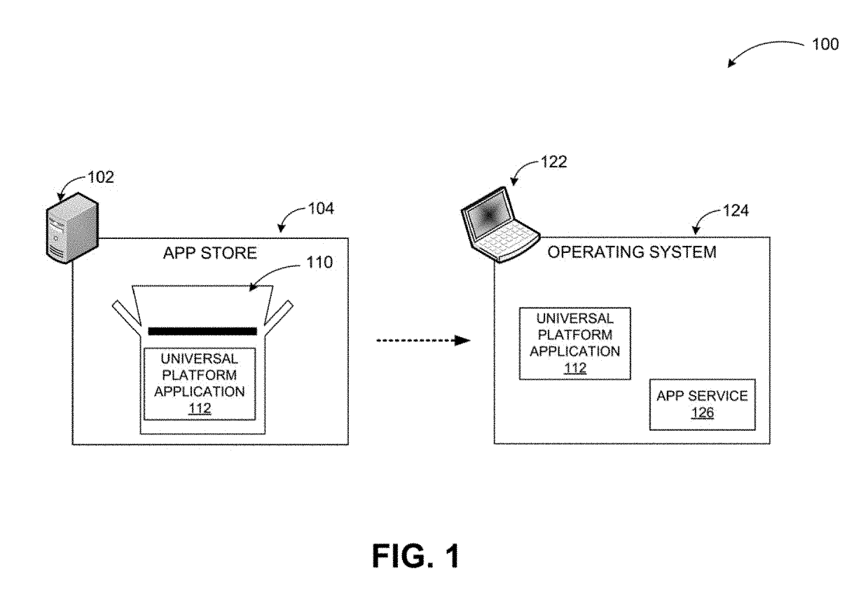

FIG. 1 illustrates conceptually a universal platform application and its installation on a computing device.

As illustrated in a diagram 100, a universal platform application 112 may be provided in a package 110 at an application store 104 executed on one or more servers such as server 102. A user may receive the package 110 and install the universal platform application 112 on their device 122 within an operating system 124. The universal platform application 112 may be executed on a number of operating systems, operating system versions, and/or devices without a need for customization or different versions of the application.

The operating system 124 may also include an application service 126. An application service may be provided by an application to advertises itself as application service provider or an operating system component. The application service may be implemented as a background task providing connectivity to an associated application. The application service application may expose the service to other applications. Thus, a foreground application may be enabled to invoke the application service in another application to perform tasks behind the scenes. An application service may also be executed in the same process as its host application.

In an example scenario, the universal platform application may be a meeting room management application executed on a server, a communal meeting device, or other similar computing device. The communal meeting device may be a special purpose device associated with one or more meeting spaces that is configured to manage meetings and ancillary devices, such as display or audio devices, in the meeting spaces. In some examples, the meeting room management application may be configured to interoperate with various applications to allow attendants to participate in a meeting, provide content to be presented in the meeting, control ancillary devices in the meeting space, and perform other meeting related activities. The various applications may be thick (locally installed) or thin (browser) applications.

As previously discussed, despite advantages and efficiencies of universal platform applications, these programs may also be associated with inherent limitations, such as an inability to interoperate with plugin modules, which may provide specific ancillary or complementary functionality. For example, meeting room applications may be provided as universal platform applications, but not control lighting, shading, temperature, or other environmental controls in a meeting room. By providing support for plugin modules at universal platform applications through application service, among others other things, computing device performance may be improved, processing and network bandwidth usage associated with a computing device may be reduced (by avoiding execution of multiple full applications), and user interaction enhanced by allowing users to control ancillary functionality through the universal platform application.

Embodiments address a need that arises from very large scale of operations created by networked computing and cloud based services that cannot be managed by humans. The actions/operations described herein are not a mere use of a computer, but address results of a system that is a direct consequence of software used as a service such as execution of universal platform applications in conjunction with plugin modules.

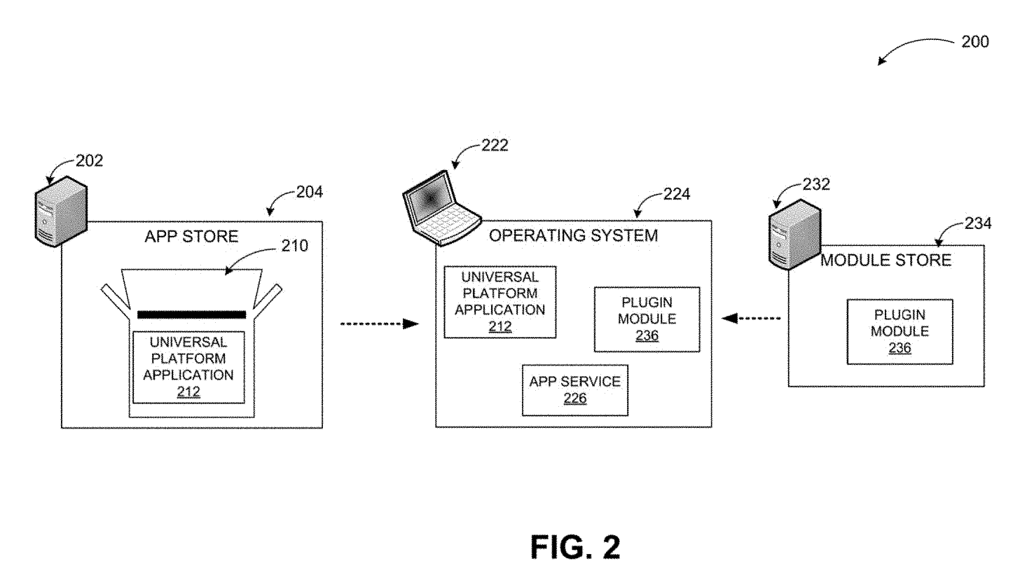

FIG. 2 illustrates conceptually a universal platform application with support for plugin modules and its installation on a computing device.

As shown in diagram 200, a universal platform application 212 may be provided in a package 210 from application store 204 executed on server 202 and installed at the operating system 224 of computing device 222, where an application service 226 may provide connectivity to the universal platform application 212.

In a system according to embodiments, a user may also receive a plugin module 236 from a module store 234 executed on server 232 and launch on the computing device 222. Upon launch, the plugin module 236 may connect to the universal platform application 212 through the applications service 226. Upon connection, the universal platform application 212 may be enabled to toggle (activate/deactivate) the plugin module. In some examples, multiple plugin modules, each directed to a different functionality, may be connected to the universal platform application 212.

When the plugin module 236 is toggled on (activated), the universal platform application 212 may hide its own user interface and send an instruction to the plugin module to display its user interface. When the plugin module is toggled off (deactivated), the universal platform application 212 may display its user interface on the foreground and send an instruction to the plugin module 236 to hide (make invisible or push to background) its user interface. The plugin module 236 may be toggled off in response to prolonged inactivity or completion of its operations. Third party plugin developers may be provided with guidance on how to connect to the universal platform application and how to interpret its instructions regarding user interface display.

In some examples, the user interface of the plugin module may be subject to best practice guidelines, but controlled completely by the plugin module. In other examples, the universal platform application may enforce restrictions on plugin module user interface.

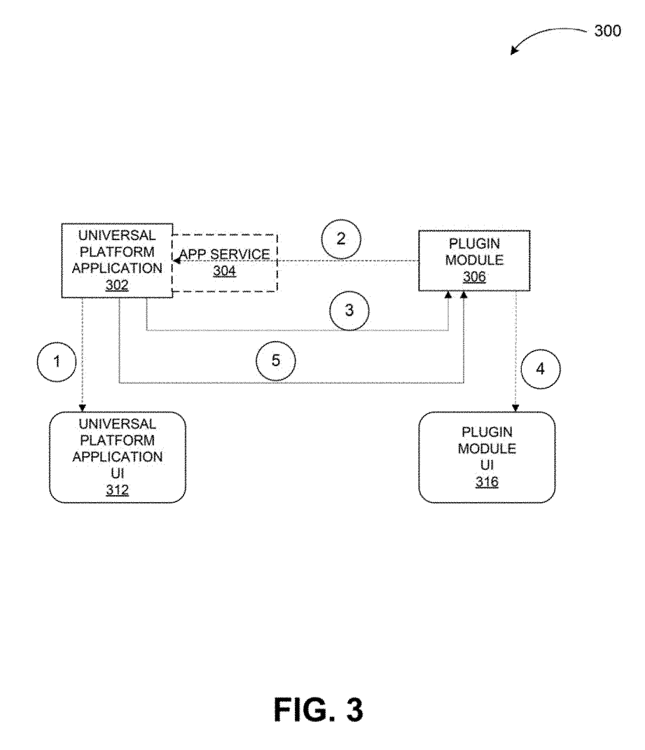

FIG. 3 includes a display diagram that conceptually illustrates providing support for plugin modules by universal platform applications through an application service interface.

Diagram 300 shows an example sequence of events in providing support for plugin modules. In an initial stage, a universal platform application 302 may operate by providing interactivity to a user through a universal platform application user interface 312. At a second stage, a plugin module 306 may connect to the universal platform application 302 through its application service 304.

As mentioned above, the application service 304 may be provided by an application that advertises itself as application service provider or an operating system component. The application service 304 may be implemented as a background task providing connectivity to an associated application (universal platform application 302). The application service application may expose the service to other applications. Thus, a foreground application may be enabled to invoke the application service in another application to perform tasks behind the scenes. An application service may also be executed in the same process as its host application.

After the initial connection, the plugin module 306 may submit a request to the universal platform application 302 to be activated (or have its user interface displayed). Upon deciding to allow the plugin module 306 to be activated, the universal platform application 302 may allow rendering of the plugin module user interface 316 in a foreground and push the universal platform application user interface 312 to a background or hide.

Upon completion of the operations of the plugin module 306 or upon detection of a predefined period of inactivity at the plugin module, the universal platform application 302 may push the plugin module user interface 316 to the background or hide, and render the universal platform application user interface 312 in the foreground again.

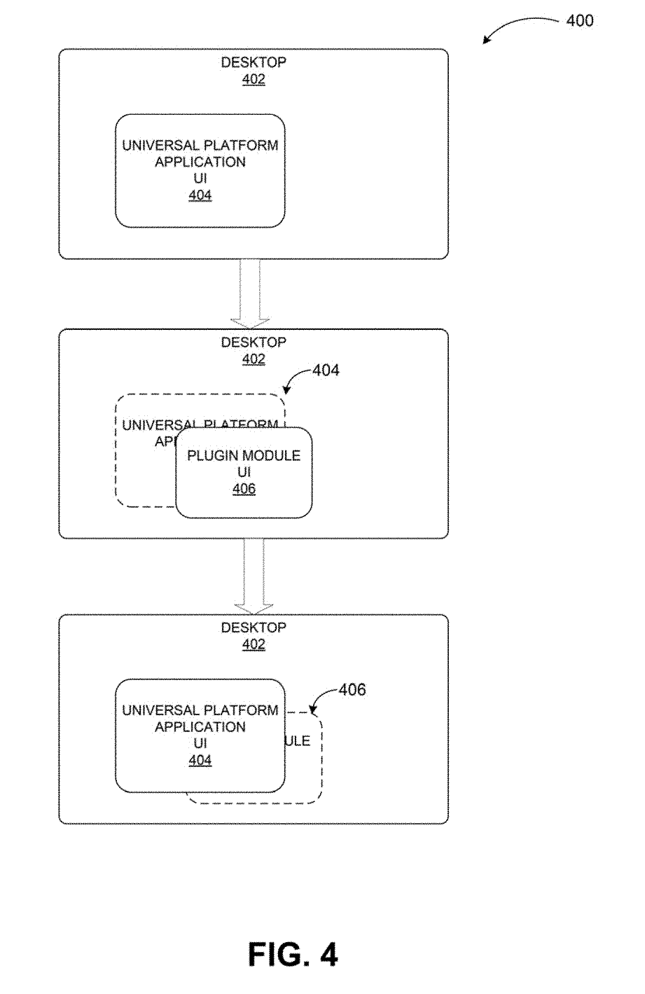

FIG. 4 illustrates an example sequence of universal platform application and plugin module user interfaces during activation and deactivation of a plugin module.

Diagram 400 shows initially a user interface of a universal platform application 404 displayed on a desktop 402. At some point during the operation of the universal platform application, a plugin module connected to the universal platform application through an application service may request activation (i.e., its user interface to be displayed). If the universal platform application finds the request acceptable or receives user input to activate the plugin module, it may allow the plugin module user interface 406 to be displayed in foreground while the universal platform application user interface 404 is pushed to the background or hidden on the desktop 402.

Upon deactivation of the plugin module in response to completion of its process(es) or expiration of an inactivity period, the universal platform application may hide or push to the background the plugin module user interface 406 and display the universal platform application user interface 404 in the foreground again. In other examples, multiple plugin module user interfaces may be displayed concurrently or sequentially. Thus, following the hiding of one plugin module's user interface, another plugin module user interface may be displayed prominently.

In one example scenario, the universal platform application may be a meeting room management application configured to facilitate and manage online meetings through a meeting room. The plugin module may be a control module configured to manage temperature controls in the meeting room. In response to detecting an increase in ambient temperature, the plugin module may send a request to the meeting room management application to display its user interface allowing a user (participant in the meeting room) to adjust the temperature. The meeting room management application may allow the plugin module user interface to be rendered in front of the user interface of the meeting room management application (or hide the meeting room management user interface) because the timing of the request is proper or in response to a user confirmation. Once the temperature adjustment through the plugin module user interface is completed or no activity is detected for a predefined period, the meeting room management application may push the plugin module user interface to the background or hide.

A textual scheme, a graphical scheme, an audio scheme, an animation scheme, a coloring scheme, a highlighting scheme, and/or a shading scheme may be employed to further enhance user interaction with a universal platform application that provides support for plugin modules.

The examples provided in FIG. 1 through FIG. 4 are illustrated with specific systems, services, applications, views, and display devices. Embodiments are not limited to environments according to these examples. Embodiments for universal platform application with support for plugin modules may be implemented in environments employing fewer or additional systems, services, applications, views, and display devices. Furthermore, the example systems, services, applications, views, and display devices shown in FIG. 1 through FIG. 4 may be implemented in a similar manner with other values using the principles described herein.

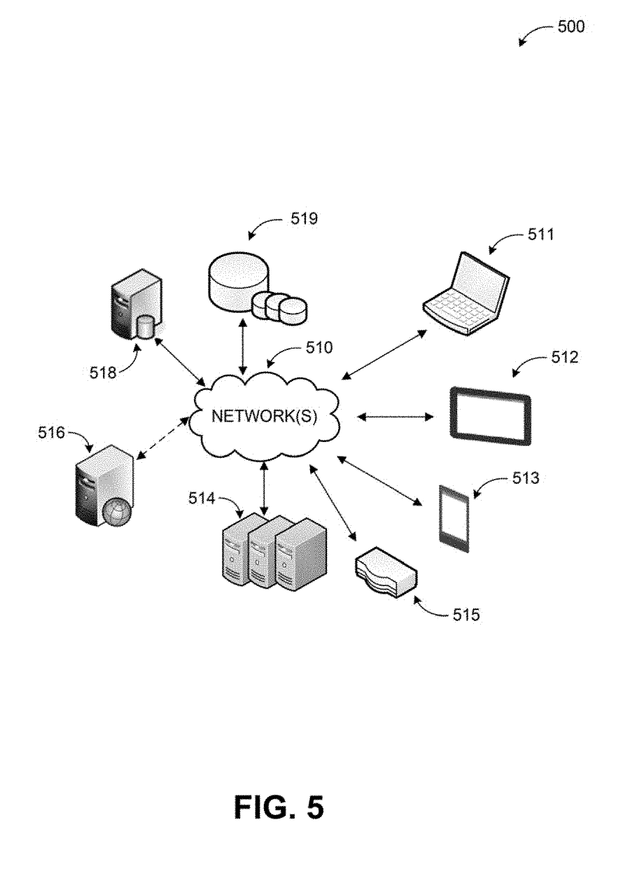

FIG. 5 is a networked environment, where a system according to embodiments may be implemented.

As shown in a diagram 500, a universal platform service may be configured to launch a universal platform application with support for plugin modules. The universal platform service may be implemented in a networked environment over one or more networks, such as a network 510. Participants may access the universal platform service through locally installed client applications or thin (e.g., browser-based) client applications executed on a variety of computing/client devices (e.g., a laptop 511, a tablet 512, and/or a smartphone 513, etc.). Functionality within the universal platform service may be provided by one or more universal platform applications executed on servers 514, special purpose device 515, or processing server 516.

The servers 514, may include one or more processing server 516, where at least one of the one or more processing servers 516 may be configured to execute one or more applications associated with the universal platform service. The universal platform service may store data associated with a meeting in a data store 519 directly or through a database server 518.

The network 510 may comprise any topology of servers, clients, Internet service providers, and communication media. A system according to embodiments may have a static or dynamic topology. The network 510 may include multiple secure networks, such as an enterprise network, an unsecure network, or the Internet. The unsecure network may include a wireless open network. The network 510 may also coordinate communication over other networks, such as Public Switched Telephone Network (PSTN) or cellular networks. Furthermore, the network 510 may include multiple short-range wireless networks, such as Bluetooth, or similar ones. The network 510 may provide communication between the nodes described herein. By way of example, and not limitation, the network 510 may include wireless media. The wireless media may include, among others, acoustic media, RF media, infrared media, and other wireless media.

Many other configurations of computing devices, applications, engines, modules, data sources, and data distribution systems may be employed for providing universal platform applications with support for plugin modules. Furthermore, the networked environments discussed in FIG. 5 are for illustration purposes only. Embodiments are not limited to the example applications, modules, engines, or processes.

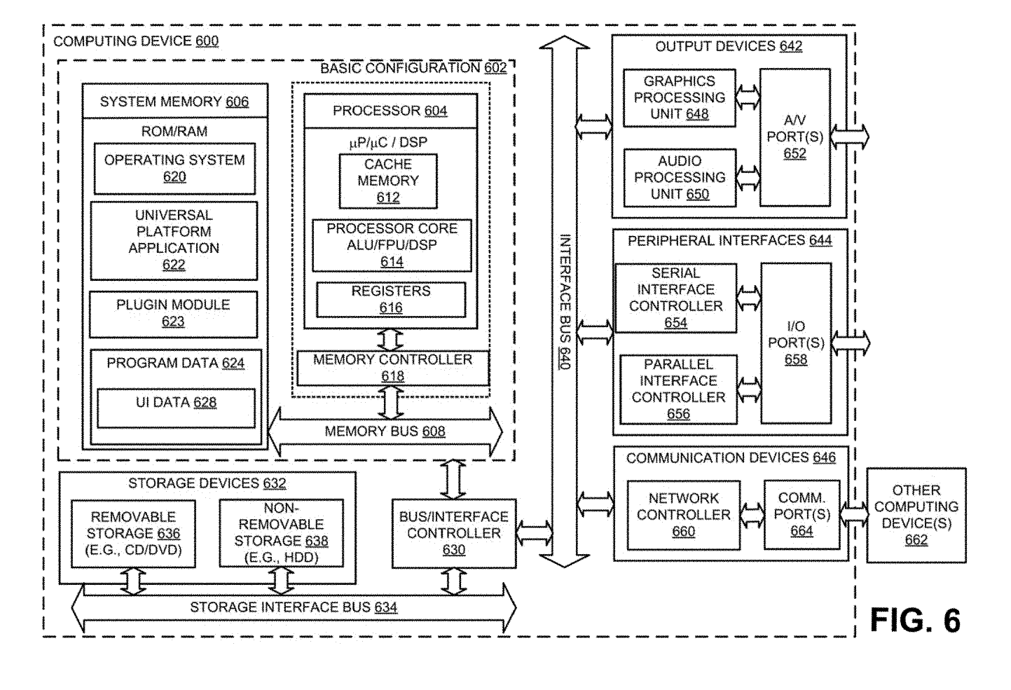

FIG. 6 is a block diagram of an example computing device, which may be used to execute a universal platform application with support for plugin modules, according to at least some embodiments described herein.

For example, a computing device 600 may be a special purpose device composed of generic and special purpose hardware and software components or a special purpose component integrated into a general purpose computing device. In an example basic configuration 602, the computing device 600 may include one or more processors 604 and a system memory 606. A memory bus 608 may be used for communicating between the processor 604 and the system memory 606. The example basic configuration 602 is illustrated in FIG. 6 by those components within the inner dashed line.

Depending on the desired configuration, the processor 604 may be of any type, including but not limited to a microprocessor (μP), microcontroller (μC), a digital signal processor (DSP), or any combination thereof. The processor 604 may include one more levels of caching, such as a level cache memory 612, one or more processor cores 614, and registers 616. The one or more processor cores 614 may (each) include an arithmetic logic unit (ALU), a floating point unit (FPU), a digital signal processing core (DSP Core), or any combination thereof. An example memory controller 618 may also be used with the processor 604, or in some implementations the example memory controller 618 may be an internal part of the processor 604.

Depending on the desired configuration, the system memory 606 may be of any type including but not limited to volatile memory (such as RAM) and non-volatile memory (such as ROM, flash memory, etc.), or any combination thereof. The system memory 606 may include an operating system 620, a universal platform application 622, and program data 624. The universal platform application 622 may provide connectivity to plugin module 623 through an application service and manage display of plugin module user interface in relation to the universal platform application user interface. The program data 624 may include user interface data 628.

The computing device 600 may have additional features or functionality, and additional interfaces to facilitate communications between the example basic configuration 602 and any desired devices and interfaces. For example, a bus/interface controller 630 may be used to facilitate communications between the example basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and an example communication device 646) to the example basic configuration 602 via the bus/interface controller 630. Some of the one or more output devices 642 may include a graphics processing unit 648 and an audio processing unit 650, which may be configured to communicate with various external devices, such as a display or speakers via one or more A/V ports 652. The one or more peripheral interfaces 644 may include a serial interface controller 654 or a parallel interface controller 656, which may be configured to communicate with external devices, such as input devices (e.g., a keyboard, a mouse, a pen, a voice input device, and/or a touch input device, etc.) or other peripheral devices (e.g., a printer and/or a scanner, etc.) via one or more I/O ports 658. The example communication device 646 may include a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. The communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, the communication media may include wired media such as a wired network or direct-wired connection, and wireless media such as acoustic, radio frequency (RF), microwave, infrared (IR) and other wireless media. The term computer readable media, as used herein, may include both storage media and communication media.

Example embodiments may also include methods for providing universal platform applications with support for plugin modules. These methods can be implemented in any number of ways, including the structures described herein. One such way may be by machine operations of devices of the type described in the present disclosure. Another optional way may be for one or more of the individual operations of the methods to be performed in conjunction with one or more human operators performing some of the operations while other operations may be performed by machines. These human operators need not be co-located with each other, but each can be only with a machine that performs a portion of the program. In other embodiments, the human interaction can be automated such as by pre-selected criteria that may be machine automated.

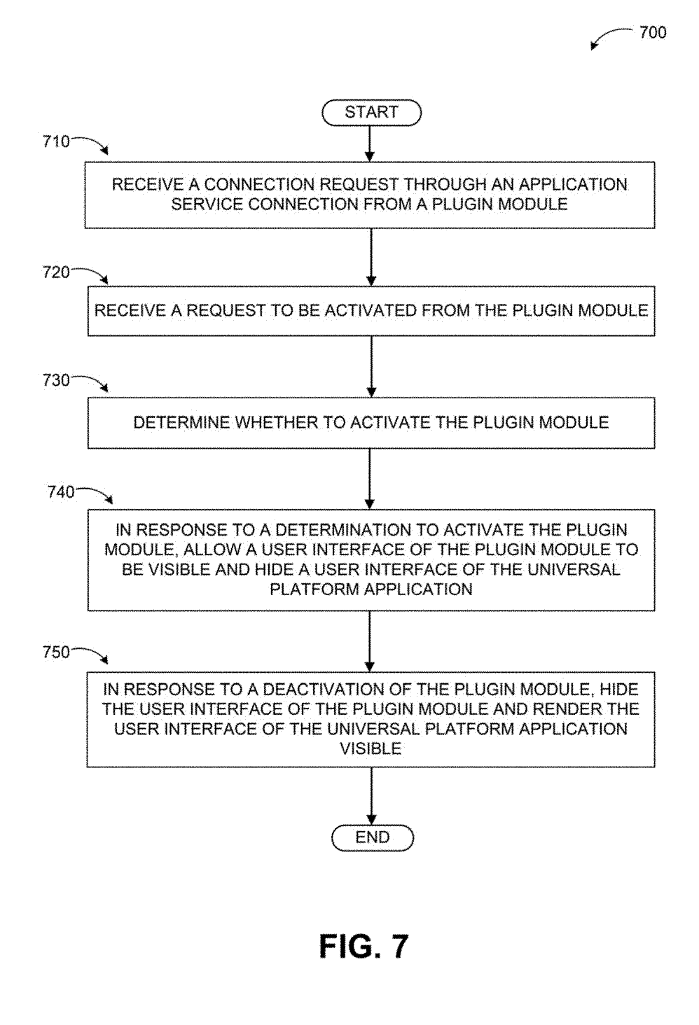

FIG. 7 includes a logic flow diagram that illustrates a process for providing universal platform application support for plugin modules, according to at least some embodiments disclosed herein.

Process 700 may be implemented on a computing device, a server, or another system, such as a communal meeting device. An example computing device may include a communication interface, one or more sensors, a memory, and a processor. The communication interface may be configured to facilitate an exchange of data with other computing devices. The one or more sensors may be configured to detect an activity within a meeting room. The memory may be configured to store instructions. The processor may be coupled to the communication interface, the one or more sensors, and/or the memory, among other components.

Process 700 begins with operation 710, where a connection request may be received from a plugin module at a universal platform application through an application service. The request may be sent by the plugin module upon launch of the plugin module at the same computing device as the universal platform application. At operation 720, the universal platform application may receive a request for activation from the plugin module. At operation 730, the universal platform application may determine whether to activate the plugin module (i.e., allow its user interface to be made visible). At operation 740, the user interface of the plugin module may be made visible in the forefront and the universal platform application user interface may be pushed to background or hidden in response to an affirmative determination. At operation 750, the plugin module user interface may be hidden or pushed to the background while the universal platform application user interface is brought back to the foreground in response to deactivation of the plugin module (either based on time expiration or completion of the plugin module operation).

In an example scenario, the universal platform application may be a meeting room management application configured to facilitate and manage online meetings through a meeting room. The plugin module may be a control module configured to manage lighting in the meeting room. In response to detecting a wall display being activated, the plugin module may send a request to the meeting room management application to display its user interface allowing a user (participant in the meeting room) to adjust the lighting. Because the timing of the request is proper or in response to a user confirmation, the meeting room management application may allow the plugin module user interface to be rendered in front of the user interface of the meeting room management application (or hide the meeting room management user interface). Once the lighting adjustment through the plugin module user interface is completed or no activity is detected for a predefined period, the meeting room management application may push the plugin module user interface to the background or hide.

The operations included in process 700 are for illustration purposes. Support for plugin modules in universal platform applications may be implemented by similar processes with fewer or additional steps, as well as in a different order of operations using the principles described herein. The operations described herein may be executed by one or more processors operated on one or more computing devices, one or more processor cores, specialized processing devices, and/or general purpose processors, among other examples.

According to examples, a means for providing universal platform application support for plugin modules is described. The means may include a means for receiving a connection request at a universal platform application through an application service connection from a plugin module; a means for determining whether to activate the plugin module in response to receiving a request to be activated from the plugin module; a means for allowing a user interface of the plugin module to be visible and a means for hiding a user interface of the universal platform application in response to a determination to activate the plugin module; and a means for hiding the user interface of the plugin module and making the user interface of the universal platform application visible in response to a deactivation of the plugin module.

According to some examples, a method executed on a compiling device to provide universal platform application support for plugin modules is described. The method may include receiving a connection request at a universal platform application through an application service connection from a plugin module; in response to receiving a request to be activated from the plugin module, determining whether to activate the plugin module; in response to a determination to activate the plugin module, allowing a user interface of the plugin module to be visible and hiding a user interface of the universal platform application; and in response to a deactivation of the plugin module, hiding the user interface of the plugin module and making the user interface of the universal platform application visible.

According to other examples, receiving the connection request at the universal platform application through the application service connection may include receiving the connection request upon launching of the plugin module on the computing device. Allowing the user interface of the plugin module to be visible may include transmitting an instruction to the plugin module to render the user interface of the plugin module. Hiding the user interface of the universal platform application may include rendering the user interface of the universal platform application invisible by minimizing. Hiding the user interface of the universal platform application may include placing the user interface of the universal platform application in a background.

According to further examples, hiding the user interface of the plugin module may include transmitting an instruction to the plugin module to hide the user interface of the plugin module. Hiding the user interface of the plugin module may include rendering the user interface of the plugin module invisible by minimizing or placing the user interface of the plugin module in a background. Making the user interface of the universal platform application visible may include placing the user interface of the universal platform application in a foreground. The method may also include enforcing one or more restrictions on the user interface of the plugin module by the universal platform application. The method may further include relinquishing control of the user interface of the plugin module to the plugin module.

According to other examples, a computing device configured to provide universal platform application support for plugin modules is described. The computing device may include a communication interface configured to facilitate exchange of data with other computing devices and display devices; a memory configured to store instructions; and a processor coupled to the communication interface, the display devices, and the memory. The processor may be configured to execute a plugin module and a universal platform application, where the universal platform application is configured to receive a connection request through an application service connection from a plugin module; in response to receiving a request to be activated from the plugin module, determine whether to activate the plugin module; in response to a determination to activate the plugin module, allow a user interface of the plugin module to be visible and hide a user interface of the universal platform application; and in response to a deactivation of the plugin module, hide the user interface of the plugin module and make the user interface of the universal platform application visible.

According to some examples, the universal platform application, may be configured to detect the deactivation of the plugin module by detecting a completion of a process associated with the plugin module. The universal platform application may be configured to detect the deactivation of the plugin module by detecting an expiration of a predefined period of inactivity of the plugin module. The application service connection may be provided by an application service provider installed on the computing device prior to an installation of the universal platform application. The application service connection may also be provided by an application service provider installed on the computing device from a package that also includes the universal platform application.

According to further examples, a meeting room management device configured to provide universal platform application support for plugin modules is described. The meeting room management device may include a communication interface configured to facilitate exchange of data with computing devices and ancillary devices in a meeting space; a memory configured to store instructions; and a processor coupled to the communication interface, the ancillary devices, and the memory, where the processor may be configured to execute one or more plugin modules and a universal platform application. The universal platform application may be configured to receive a connection request through an application service connection from the one or more plugin modules upon launch of each plugin module; in response to receiving a request to be activated from each plugin module, determine whether to activate a requesting plugin module; in response to a determination to activate the requesting plugin module, transmit an instruction to the requesting plugin module to make a user interface of the plugin module visible and hide a user interface of the universal platform application; and in response to detecting a deactivation of one of the one or more plugin modules based on a completion of a process or an expiration of a predefined period of inactivity associated with the one of the one or more plugin modules, hide the user interface of the one of the one or more plugin modules and make the user interface of another one of the one or more plugin modules or the user interface of the universal platform application visible.

According to other examples, the universal platform application may be further configured to upon hiding the user interface of the one of the one or more plugin modules and prior to making the user interface of the universal platform application visible, make the user interface of another one of the one or more plugin modules visible. The universal platform application may also be configured to determine whether to activate the requesting plugin module based on a state of the universal platform application or a user input The one or more plugin modules may be configured to perform control functionalities associated with one or more of lighting, shading, environmental conditions of the meeting space.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to provide universal platform application support for plugin modules, the method comprising:
receiving a connection request at a universal platform application through an application service connection from a plugin module;
in response to receiving a request to be activated from the plugin module, determining whether to activate the plugin module;
in response to a determination to activate the plugin module, allowing a user interface of the plugin module to be visible and hiding a user interface of the universal platform application; and
in response to a deactivation of the plugin module, hiding the user interface of the plugin module and making the user interface of the universal platform application visible.

2. The method of claim 1, wherein receiving the connection request at the universal platform application through the application service connection comprises:
receiving the connection request upon launching of the plugin module on the computing device.

3. The method of claim 1, wherein allowing the user interface of the plugin module to be visible comprises:
transmitting an instruction to the plugin module to render the user interface of the plugin module.

4. The method of claim 3, wherein hiding the user interface of the universal platform application comprises:
rendering the user interface of the universal platform application invisible by minimizing.

5. The method of claim 3, wherein hiding the user interface of the universal platform application comprises:
placing the user interface of the universal platform application in a background.

6. The method of claim 1, wherein hiding the user interface of the plugin module comprises:
transmitting an instruction to the plugin module to hide the user interface of the plugin module.

7. The method of claim 6, wherein hiding the user interface of the plugin module comprises:
rendering the user interface of the plugin module invisible by minimizing.

8. The method of claim 6, wherein hiding the user interface of the plugin module comprises:
placing the user interface of the plugin module in a background.

9. The method of claim 6, wherein making the user interface of the universal platform application visible comprises:
placing the user interface of the universal platform application in a foreground.

10. The method of claim 1, further comprising:
enforcing one or more restrictions on the user interface of the plugin module by the universal platform application.

11. The method of claim 1, further comprising:
relinquishing control of the user interface of the plugin module to the plugin module.

12. A computing device configured to provide universal platform application support for plugin modules, the computing device comprising:
a communication interface configured to facilitate exchange of data with other computing devices and display devices;
a memory configured to store instructions; and
a processor coupled to the communication interface, the display devices, and the memory, wherein the processor is configured to execute:
a plugin module and a universal platform application, wherein the universal platform application is configured to:
receive a connection request through an application service connection from a plugin module;
in response to receiving a request to be activated from the plugin module, determine whether to activate the plugin module;
in response to a determination to activate the plugin module, allow a user interface of the plugin module to be visible and hide a user interface of the universal platform application; and
in response to a deactivation of the plugin module, hide the user interface of the plugin module and make the user interface of the universal platform application visible.

13. The computing device of claim 12, wherein the universal platform application is configured to detect the deactivation of the plugin module by detecting a completion of a process associated with the plugin module.

14. The computing device of claim 12, wherein the universal platform application is configured to detect the deactivation of the plugin module by detecting an expiration of a predefined period of inactivity of the plugin module.

15. The computing device of claim 12, wherein the application service connection is provided by an application service provider installed on the computing device prior to an installation of the universal platform application.

16. The computing device of claim 12, wherein the application service connection is provided by an application service provider installed on the computing device from a package that also includes the universal platform application.

17. A meeting room management device configured to provide universal platform application support for plugin modules, the meeting room management device comprising:
a communication interface configured to facilitate exchange of data with computing devices and ancillary devices in a meeting space;
a memory configured to store instructions; and
a processor coupled to the communication interface, the ancillary devices, and the memory, wherein the processor is configured to execute one or more plugin modules and a universal platform application, wherein the universal platform application is configured to:
receive a connection request through an application service connection from the one or more plugin modules upon launch of each plugin module;
in response to receiving a request to be activated from each plugin module, determine whether to activate a requesting plugin module;
in response to a determination to activate the requesting plugin module, transmit an instruction to the requesting plugin module to make a user interface of the plugin module visible and hide a user interface of the universal platform application; and
in response to detecting a deactivation of one of the one or more plugin modules based on a completion of a process or an expiration of a predefined period of inactivity associated with the one of the one or more plugin modules, hide the user interface of the one of the one or more plugin modules and make the user interface of another one of the one or more plugin modules or the user interface of the universal platform application visible.

18. The meeting room management device of claim 17, wherein the universal platform application is further configured to:
upon hiding the user interface of the one of the one or more plugin modules and prior to making the user interface of the universal platform application visible, make the user interface of another one of the one or more plugin modules visible.

19. The meeting room management device of claim 17, wherein the universal platform application is configured to determine whether to activate the requesting plugin module based on a state of the universal platform application or a user input.

20. The meeting room management device of claim 17, wherein the one or more plugin modules are configured to perform control functionalities associated with one or more of lighting, shading, environmental conditions of the meeting space.
